(19) United States
(12) Patent Application Publication
(10) Pub. No.: US 2010/0089056 A1
(43) Pub. Date: Apr. 15, 2010

(54) INTEGRATED TURBO-BOOSTING AND ELECTRIC GENERATION SYSTEM AND METHOD

(75) Inventors: Jared Klineman Cooper, Palm Bay, FL (US); John Brand, Melbourne, FL (US); Mark Kraeling, Melbourne, FL (US); Nick Nagrodsky, Melbourne, FL (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: General Electric Company, Schenectady, NY (US)

(21) Appl. No.: 12/248,528

(22) Filed: Oct. 9, 2008

(51) Int. Cl. F02B 33/34; F01D 15/10

(52) U.S. Cl. 60/605.1; 290/52

(57) ABSTRACT

An integrated turbo-boosting system for an engine system including an internal combustion engine, the internal combustion engine having at least one combustion chamber with an intake system and an exhaust system. The integrated turbo-boosting system includes a turbo-boosting device including a compressor coupled to a turbine by a rotating shaft, the turbine driven by exhaust gas, and an electric generation system integrated into a portion of the turbo-boosting device, the electric generation system configured to generate electricity for an electrical system. The electric generation system is maintained at an operation temperature through direction of an intake gas around at least a portion of the electric generation system. The integrated turbo-boosting system is operated in a first mode to compress intake gas for supply to the engine and a second mode to generate electrical power.

### BACKGROUND

Turbo-boosting devices, such as turbochargers, may be utilized in a variety of engine systems to provide compression of intake gas (e.g. air), increasing the power output and decreasing fuel consumption and emissions in the engine system. The turbo-boosting devices may allow the size and weight of the engine to be decreased, while enabling production of a substantially equivalent amount of power. However, operation of the turbo-boosting device to compress intake gas may not be needed under some engine operating conditions. Further, under other operating conditions, compression may be disadvantageous due to the constraints of combustion. During such operating conditions, use of the turbo-boosting device may be discontinued or unused and the spinning action of the turbo-boosting device may be wasted.

Engineers have tried to incorporate an electric generation system, such as a generator, into a turbocharger, to convert the unused mechanical energy in the turbocharger to electrical energy. For example, attempts have been made to incorporate a generator into a central rotating shaft coupling a turbine to a compressor in a turbocharger. However, the temperature of the generator may become very high, due to the heat transfer from a high temperature exhaust gas to the central rotating shaft through a turbine as well as other components included in the engine. Consequently, operation of the generator may become degraded due to the elevated temperature. In some examples, the efficiency of the generator may be decreased by 50% or more when the temperature of the generator increases above an acceptable level during operation.

### BRIEF DESCRIPTION OF THE INVENTION

The inventors herein have recognized various systems and method to address the issues above. In one example, the above issues may be addressed by an integrated turbo-boosting system for an engine system including an internal combustion engine, the internal combustion engine having at least one combustion chamber with an intake system and an exhaust system. The integrated turbo-boosting system includes a turbo-boosting device having a compressor coupled to a turbine by a rotating shaft, with the turbine being driven by exhaust gas. The system also includes an electric generation system integrated into a portion of the turbo-boosting device. The electric generation system is configured to generate electricity for an electrical system, and is maintained at an operation temperature through direction of an intake gas around at least a portion of the electric generation system (e.g., for cooling purposes). The integrated turbo-boosting system is operated in a first mode to compress intake gas for supply to the engine and a second mode to generate electrical power.

In this way it is possible to provide increased engine power output from a turbo-boosting device as well as to extract electrical power from the electric generation system integrated into the turbo-boosting device. Therefore, the efficiency and performance of the engine can be increased, which in turn may reduce the size and the cost of the engine.

This brief description is provided to introduce a selection of concepts in a simplified form that are further described herein. This brief description is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure. Also, the inventors herein have recognized any identified issues and corresponding solutions.

### DESCRIPTION OF THE FIGURES

The present invention will be better understood from reading the following description of non-limiting embodiments, with reference to the attached drawings, wherein below:

FIG. 1 shows a schematic diagram of an engine system;

FIG. 2 shows a schematic diagram of a first embodiment of an integrated turbo-boosting system including a turbo-boosting device and an electric generation system;

FIG. 3 shows a schematic diagram of a second embodiment of an integrated turbo-boosting system; and

FIGS. 4-5 show flow charts illustrating example methods for generating electrical power in an integrated turbo-boosting system.

### DETAILED DESCRIPTION

Engine systems may include turbo-boosting devices (e.g. turbochargers) to improve performance, reduce regulated emissions, and decrease the size and weight of the engine while producing a substantially equivalent amount of power. However, under various operating conditions, compression of intake gas by the turbo-boosting system may not be needed. As described in more detail below, an integrated turbo-boosting system including a turbo-boosting device and an integrated electric generation system may enable extraction of electrical power without sacrificing engine performance. For example, the disclosed integrated turbo-boosting system may operate in a first and a second mode. In the first mode the integrated turbo-boosting system compresses intake gas, thereby increasing the power output of the engine. In the second mode, the integrated turbo-boosting system produces electricity. In some examples, the electricity may be transferred to an electrical system, such as but not limited to, a vehicle electrical system which may include a cabin heating and/or cooling system, audio system, display system, etc.

Additionally, the electric generation system in the present disclosure may be positioned at various locations in the turbo-boosting device where the electric generation system can be maintained at an operation temperature above which a predetermined efficiency is substantially reduced. In this way, degraded efficiency due to high operating temperatures of the electric generation system may be avoided. For example, the electric generation system may be positioned so that intake gas may be directed around at least a portion of the electric generation system, facilitating heat transfer from the electric generation system to the intake gas. The proceeding description illustrates various examples of such systems and methods.

As described herein, an operation temperature may include a temperature or temperature range in which the electrical generation system operates above a given efficiency. For example, a suitable operation temperature may be a temperature below 500° F. (260° C.), allowing the electric generation system to operate at an efficiency above 50%.

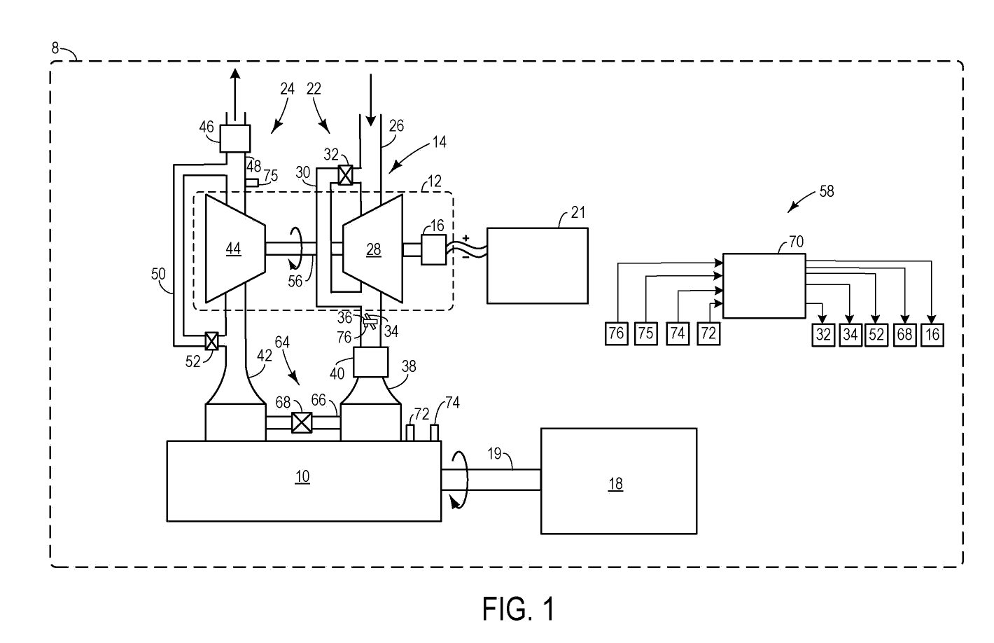

FIG. 1 schematically illustrates an engine system 8 with an internal combustion engine 10 and an integrated turbo-boosting system 12. In some examples, the engine system may be included in a vehicle such as a locomotive, car, truck, boat, etc. Alternatively, the engine system may be included in another suitable device such as a generator used to provide electrical power in a building. The integrated turbo-boosting system includes a turbo-boosting device 14 to generate mechanical power by providing compressed intake gas to the engine and an electric generation system 16 to generate electrical power. In this example, the turbo-boosting device includes a turbine 44 coupled to a compressor 28 through a central rotating shaft or other axis 56. In other examples, the turbo-boosting device may include additional components such as a wastegate 52, discussed in greater detail herein.

As an integrated turbo-boosting system, two different types of power generating systems, a mechanical power generating system and an electrical power generating system, are combined into a combined power unit. For example, the integrated system utilizes the spinning action of the turbo-boosting device as a mechanical power generating system to compress air into an engine, to increase the compression into the engine, while also utilizing the spinning action of the turbo device for the electrical power generating system.

Referring back to FIG. 1, engine 10 may operate to drive a transmission 18 coupled to the engine through a transmission drive shaft 19, e.g., for mechanical vehicular traction purposes, or for driving an alternator used for generating electricity to power a traction motor. The engine 10 may include a plurality of combustion chambers (e.g. cylinders) coupled between an intake system 22 and an exhaust system 24. Each combustion chamber includes at least one intake valve and one exhaust valve. The valves are configured to direct gas into and out of the combustion chamber during selected intervals to perform combustion.

A suitable air fuel mixture may be directed into the combustion chamber. The fuel may be distributed through a fuel delivery system (not shown). A suitable fuel delivery system, such as a fuel delivery system utilizing port injection, may be used. However, it can be appreciated that alternate systems are possible, such as a fuel delivery system utilizing direct injection or a carburetor. A number of suitable fuels may be used in the fuel delivery system such as diesel, bio-diesel, hydrogen, gasoline, alcohol based fuels (e.g. methanol and/or ethanol), and combinations thereof. Moreover, various types of combustion may be utilized such as compression ignition, or various other types of engine ignition such as homogeneous charge compression ignition (HCCI), homogeneous charge spark ignition, etc. In this particular example, diesel and/or bio-diesel are combusted via compression ignition. However, it can be appreciated that other combinations of the aforementioned fuels and/or combustion types may be used.

The intake system 22 includes an intake passage 26 and a compressor 28 configured to compress the intake gas (e.g. air). A compressor bypass 30 including a bypass valve 32 may be coupled directly upstream and downstream of the compressor. Under some conditions the bypass valve 32 may be actuated to prevent surge in the turbo-boosting device. However, it can be appreciated that in other examples, the compressor bypass may not be included in the engine.

A throttle 34, having a throttle plate 36, may be located in an intake manifold 38 downstream of the compressor. Alternatively, the throttle may be positioned upstream of the compressor. The throttle may be configured to adjust the amount of intake gas traveling into the engine. Additionally, the intake manifold may include an intercooler 40 configured to remove heat from the intake gas prior to combustion, allowing the density of the intake gas to be increased, and under some conditions increasing the efficiency of combustion. It can be appreciated that a suitable intercooler may be used, such as an air-air intercooler, a fluid-based intercooler, etc. Furthermore, the size and/or number of intercoolers may be adjusted depending on the cooling requirements of the engine. The cooling requirements of the engine may be proportional to the size of the engine, the compression ratio of the compressor, the engine temperature, throttle position, and/or the ambient temperature.

Continuing with FIG. 1, the exhaust system includes an exhaust manifold 42 fluidly coupled to a turbine 44 and the engine 10. Further, the turbine may be fluidly coupled to an emission control system 46 by an exhaust conduit 48. The emission control system may include at least one of a three way catalyst, NOx trap, diesel particulate filter (DPF), selective catalytic reduction (SCR) catalyst, etc.

A turbine bypass 50 may include a wastegate 52. The wastegate may be actuated to adjust the amount of exhaust gas directed through the turbine. Exhaust gas may include the gaseous bi-products of combustion such as carbon dioxide, carbon monoxide, water (e.g. water vapor), nitrogen dioxide, nitrogen oxide, etc. Actuation and/or adjustment of a device, component, system, etc., as discussed herein may include turning the device on or off, as well as adjusting a level of actuation of the device.

During operation of the turbo-boosting device exhaust gas may drive the turbine 44, thereby rotating a rotating shaft 56 and driving the compressor 28. In some examples, the rotating shaft is a central rotating shaft. In this way the intake gas is compressed, increasing the power generated in combustion. In one additional example, the turbo-boosting device may further include the turbine bypass and/or the compressor bypass.

Alternatively or additionally, various types of turbo-boosting devices (e.g. turbochargers) and/or arrangements may be used. For example, a variable geometry turbocharger (VGT) may be used where the geometry of the turbine and/or compressor may be varied during engine operation by a control system 58, thus the compression ratio may be varied. Alternately, or in addition, a variable nozzle turbocharger (VNT) may be used wherein a variable area nozzle is placed upstream and/or downstream of the turbine in the exhaust line (and/or upstream or downstream of the compressor in the intake line) for varying the effective expansion or compression of gasses through the turbocharger. Still other approaches may be used for varying expansion in the exhaust, such as the wastegate 52.

Also, a twin turbocharger arrangement, and/or a sequential turbocharger arrangement, may be used. In the case of multiple adjustable turbocharger and/or stages, the relative amount of expansion though the turbocharger may be varied, depending on operating conditions (e.g., manifold pressure, airflow, and/or engine speed).

In the turbo-boosted engine, requested torque may also be maintained by adjusting various valves such as the wastegate valve and/or compressor bypass valve. The wastegate and compressor bypass valves allow gas to be redirected around the turbine and the compressor. The control system 58 can thereby adjust the wastegate and/or compressor bypass valves to regulate the amount of boost provided by the turbo-boosting device, as well as regulate the exhaust gas temperature and pressure downstream of the turbine. Under some conditions, the wastegate, compressor bypass, and/or the electric generation system may be adjusted in response to a request for torque and/or electrical power demand.

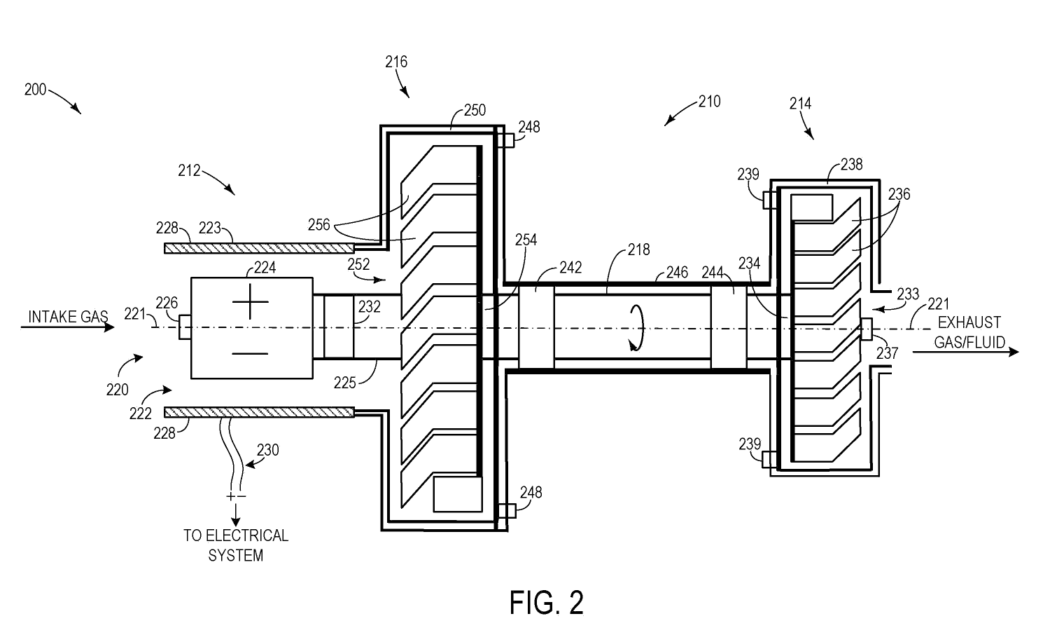

Continuing with FIG. 1, the electric generation system 16 may include a rotor and a stator configured to electromagnetically interact. (Example embodiments including a rotor 224 and stator 228 are described in more detail with respect to FIG. 2 below.) The stator includes a stationary section of the electric generation system. Furthermore, the rotor includes a non-stationary section of the electric generation system. Still further, the electric generation system may be an electrical generator including an alternator configured to generate alternating current (A/C), discussed in more detail herein.

The electric generation system 16 may be coupled to an electrical system 21. The electrical system may include at least one of a battery, a heating system and/or cooling system, a lighting system, an audio system, a cabin heating and/or cooling system, etc. In this way, electrical power generated from the electric generation system may be transferred and/or stored for use in the electrical system. The electric generation system may exclusively provide electrical power to the aforementioned devices, systems, etc. included in the electrical system. Therefore, the parasitic loads on alternate electric generation systems in the vehicle, such as an alternator, which may be coupled to the transmission 18, may be decreased.

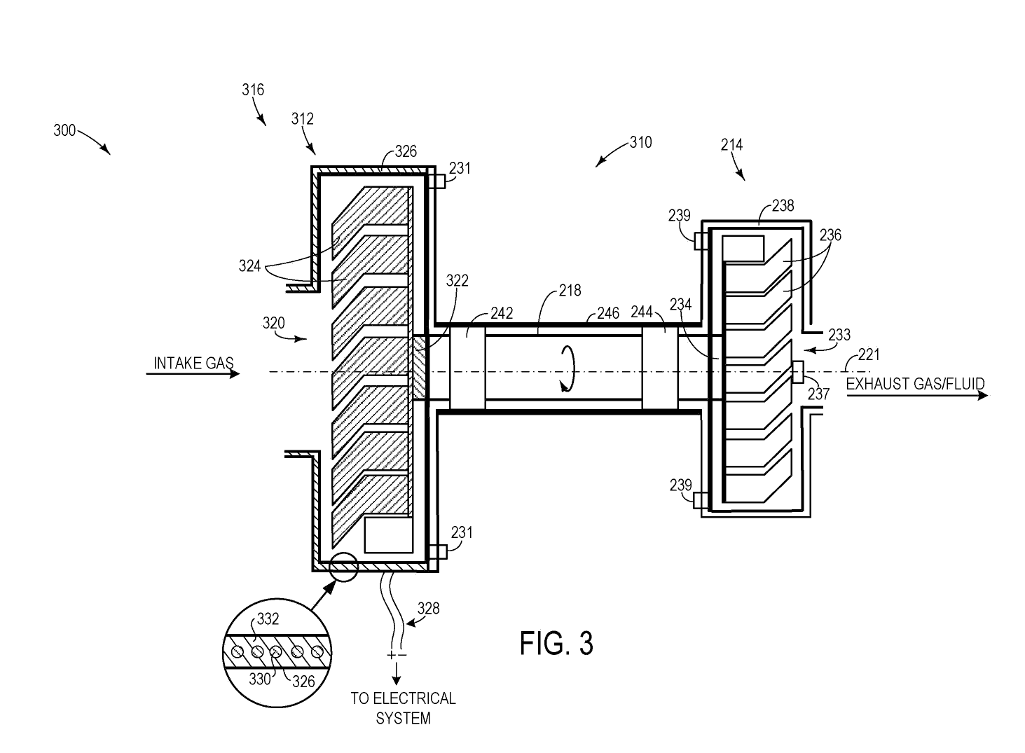

FIG. 1 illustrates the electric generation system 16 integrated into a portion of the turbo-boosting device 12 exterior to the compressor and the intake passage. However, it can be appreciated that the electric generation system may be integrated into other suitable locations in the turbo-boosting device where the heat transferred to the electric generation system from various components will not substantially decrease the efficiency of the electrical generation system. For example, the electric generation system may be integrated into the compressor or integrated into a portion of the turbo-boosting device enclosed by an intake passage, discussed in more detail herein with regard to FIG. 2 and FIG. 3.

The control system 58 may include a controller 70 receiving various sensor inputs, and communicating with various actuators. In one example, the sensors may include at least one of an engine temperature sensor 72, an engine speed sensor 74, an exhaust composition sensor 75, and a throttle position sensor 76. The actuators may include at least one of the electric generation system 16, the throttle 34, the wastegate 52, the compressor bypass valve 32, an EGR (exhaust gas recirculation) valve 68, etc. Further, when a variable geometry compressor is used the compressor may be an actuator.

Additionally, an EGR system 64 may be included in the engine. The EGR system includes an EGR conduit 66 configured to direct exhaust gas from the exhaust manifold to the intake manifold. Further, the EGR valve 68, configured to adjust the amount of gas traveling through the EGR conduit, may be included in the EGR system. In some examples, the EGR may be adjusted to reduce the emissions from the engine.

Also, a crank-shaft electric generation system may be included in the engine system. The crank-shaft electric generation system may be operably coupled to the transmission or the engine. In this example, the crank-shaft electric generation system is a generator, such as an alternator, including a stator and a rotor configured to generate electrical current. A stator may include a stationary section of the electric generation system. Furthermore, the rotor includes a non-stationary section of the electric generation system. However, in other examples, another suitable crank-shaft electric generation system may be utilized or alternatively the crank-shaft electric generation system may not be included in the engine system. The crank-shaft electric generation system may be coupled to various electrical components in the engine system, such as a battery which may be coupled to a starter motor.

The integrated turbo-boosting system 12 may be operated in a first and second mode. In the first mode, the integrated turbo-boosting system compresses intake gas, thereby increasing the power produced by the engine. In a second mode, the integrated turbo-boosting system generates electricity. The aforementioned modes may be performed at substantially concurrent, overlapping, or separate time intervals, responsive to various operating conditions. By “substantially concurrent,” it is meant concurrent but takes into account any time differences in operation between the two modes brought upon by processor/controller delays and/or delays inherent to the operation of any mechanical components such as the time required for a valve to be actuated and opened or closed. In this way, electrical power generation and intake gas compression may be provided by a single system, increasing the efficiency of the engine system. Such a system may reduce or eliminate the need for an alternator in some engine systems. As such, the integrated turbo-boosting system reduces engine system parts, allows for smaller engines with equivalent power, and may add more electrical power into the system to charge batteries and enables more electrical power per unit volume of fuel burned.

The control system 58 may be used to adjust the integrated turbo-boosting system, the engine 10, the intake system 22, and/or exhaust system 24 to operate the integrated turbo-boosting system in the first and/or the second mode. Specifically, the wastegate, compressor bypass valve, EGR system and/or throttle may be adjusted to operate the integrated turbo-boosting system in the first mode. Various sub-systems, such as circuits included in the electrical system or electric generation system, as well as the wastegate, compressor bypass valve, EGR system, and/or throttle, may be adjusted to operate the integrated turbo-boosting system in the second mode. Alternatively, the integrated turbo-boosting system may be passively adjusted to operate in the first and/or second modes. Further in one example, the integrated turbo-boosting system may be operated in the second mode in response to a request for power from the electrical system. Additionally, the first mode may be discontinued or adjusted while the integrated turbo-boosting system is operated in the second mode.

Still further, in some examples, the integrated turbo-boosting system may be operated in the second mode when an excessive amount of compression is occurring or compression is simply not needed. Various operating conditions may be used to determine the required amount of compression such as requested torque, required torque, throttle position, exhaust gas composition, engine temperature, intake air pressure, etc. Additionally, an engine efficiency curve may be used to determine when operation of the integrated turbo-boosting system can occur. However, it can be appreciated that the integrated turbo-boosting system may operate in the second mode during normal operation of the engine during which combustion cycles are occurring, regardless of engine system operating conditions.

While FIG. 1 shows a single intake and exhaust system, the engine may include a plurality of cylinder groups and/or cylinder banks. Each engine bank may include a separate exhaust and intake system in one example, and each of the various intake system components and/or exhaust system components may be duplicated for each bank.

FIGS. 2-3 illustrate a first and a second embodiment of an integrated turbo-boosting system including a turbo-boosting device and an electric generation system integrated into the turbo-boosting device. Integration includes incorporation of a system into one or more parts of a device, allowing the part(s) to perform multiple functions and serve in multiple capacities, increasing the functionality of the device. In particular, FIG. 2 shows an electric generation system integrated into a shaft extension (e.g., an extension attached to the shaft that operably interconnects the compressor and turbine) and FIG. 3 shows an electric generation system integrated into a compressor. The location of the electric generation systems in FIGS. 2 and 3, due to the heat transfer characteristics of the turbo-boosting device, allows the electric generation systems to operate at low temperatures (e.g. <500° F., 260° C.), thereby increasing the efficiency of the electric generation systems and avoiding degraded operation. It can be appreciated that the electric generation system may be integrated into additional or alternative sections or portions of the turbo-boosting device, allowing the electric generation to operate at low temperatures.

The integrated turbo-boosting systems, illustrated in FIGS. 2 and 3, have two operating modes, a first mode and a second mode, as discussed above. Additionally, the integrated turbo-boosting systems shown in FIGS. 2-3 may be similar to the integrated turbo-boosting system 12 or alternatively may be another suitable integrated turbo-boosting system.

Referring now to FIG. 2, a schematic depiction of an integrated turbo-boosting system 200 is illustrated. The integrated turbo-boosting system includes a turbo-boosting device 210 and an electric generation system 212 integrated into the turbo-boosting device. The turbo-boosting device may include a turbine 214 coupled to a compressor 216 by a rotating shaft 218 or other element that operably couples the compressor and turbine. The compressor is directly or indirectly in fluidic communication with upstream intake air or other gas (e.g., the atmosphere/ambient air) and combustion chamber(s) included in an engine, as shown in FIG. 1. In the first mode the turbine is rotated by exhaust gas, thereby rotating the rotating shaft and therefore the compressor. Thus, intake gas is compressed, increasing the power output of the engine.

In this particular example, the rotating shaft 218 extends through and past the center of the compressor, forming a shaft extension 220. The shaft extension 220 may extend axially away from the compressor, turbine, and/or rotating shaft, sharing a common axis of rotation 221. In some examples, the shaft extension is positioned upstream of the compressor within an intake conduit 222. The intake conduit may include a housing 223 (e.g. walls). In other examples, the shaft extension may be positioned at least partially exterior to the intake conduit.

In this example, part of an electric generation system 212 is coupled to the shaft extension 220. A suitable electric generation system may be utilized, such as a generator. The electric generation system includes a rotor 224 integrated into the shaft extension 220. In some examples, the rotor may be at least partially composed out of a permanent magnetic material. However, in other examples the rotor may be an electro-magnet. Further still, the rotor may be coupled to an end section 225 of the shaft extension 220, which may be non-magnetic, by a suitable rotor coupling 226, such as bolts or another fastener. During operation of the engine, intake gas may be flowed through the intake conduit 222 and around the rotor, allowing heat to be transferred from the rotor to the intake gas (e.g. air), thereby increasing the efficiency of the electric generation system.

In the illustrated embodiment, intake gas is directed around the rotor, increasing the heat transfer rate from the electric generation system to the intake gas. In this way, the electric generation system may be cooled by the intake gas, thereby increasing the power generated by the electric generation system, under some conditions. However, it can be appreciated that the electric generation system may be positioned exterior to an intake conduit.

Additionally, the electric generation system 212 may include a fixed stator 228 configured to electromagnetically interact with the rotor 224. In this example, the stator is formed by the housing 223. However, it can be appreciated that the stator may only be included in a portion of the housing. The stator may be at least partially composed of a conductive material configured to produce electrical current during rotation of the rotor (e.g., copper wire or other conductive wire wound or otherwise arranged in the housing or around the housing interior surface so that upon rotation of the rotor, electrical current is produced in the wire due to the electromagnetic interaction between the conductive wire and the rotating magnetic field produced by the rotor). In some examples, the electric generation system may be configured to produce alternating current or direct current. In the case of A/C generation a rectifier, configured to convert A/C to DC, may coupled to the stator. In the second mode, the turbine is rotated by exhaust gas, thereby rotating the rotor which electro-magnetically interacts with the stator. Thus, electrical power is generated by the electric generation system, which is driven by rotation of the turbine.

Further, the electric generation system may be coupled to an electrical system, such as the electrical system 21, discussed above with regard to FIG. 1, by a suitable coupling 230, such as leads. Under some operating conditions, a battery included in the electrical system may be configured to store power produced by the electric generation system 212. In some examples the electric generation system may be the only electric power generation system in the engine system. In this way the size and/or cost of the engine system may be reduced.

An extension coupling 232 may be attached to or otherwise included in the shaft extension located between the rotor 224 and the compressor 216. The extension coupling 232 may be at least partially formed out of a non-heat transferring material, such as a ceramic material. Thus, the extension coupling has non-heat transferring properties and decreases the amount heat transferred to the electric generation system from the turbo-boosting device, increasing the efficiency of the electrical generation system. In another example, the extension coupling may be a device configured to dissipate heat, such as an open or closed loop heat exchanger.

The turbine 214 includes a turbine rotor assembly 233 having a central turbine shaft 234 to which a plurality of turbine blades 236 is attached. The turbine rotor assembly rotates about the central rotating axis 221 during operation of the integrated turbo-boosting system. Exhaust gas may be directed through the turbine for actuating the turbine blades, thereby rotating the turbine rotor assembly and the rotating shaft 218. The turbine rotor assembly may be coupled to the rotating shaft by a suitable coupling 237, such as bolts. Further, a turbine housing 238 may at least partially enclose the turbine. The turbine housing may be coupled to a rotating shaft housing 246 by a plurality of suitable couplings 239, such as bolts. The turbine housing may have multiple layers for increasing the strength and insulating properties of the housing.

The rotating shaft 218 may rotatably couple the turbine and the compressor. Specifically in this embodiment, first and second bearings 242, 244, respectively, are coupled to the rotating shaft and the rotating shaft housing. The bearings may each be any suitable bearing, such as gas bearings, for reducing the vibration, noise, and cost of the system, as well as to extend the lifetime of the rotating components in the system. However, in other examples, the number and/or type of bearing may be altered. Alternate suitable bearing types include cylindrical roller bearings, tapered roller bearings, etc.

Additionally, the bearings may be positioned such that the loads generated by the compressor, rotating shaft, and/or turbine are adequately supported. Adequate support may include providing support to the compressor, rotating shaft, and/or turbine within a specified range, thereby reducing the stress on the aforementioned components. For example, a cylindrical roller bearing may support the majority of the radial loads from the components.

The rotating shaft housing 246 may partially enclose the rotating shaft. In this example, the rotating shaft housing is coupled directly to the compressor housing by a plurality of suitable couplings 248, such as bolts. However, it can be appreciated that in other embodiments the rotating shaft housing may be coupled to the compressor housing and/or turbine housing via additional or alternate suitable couplings. Additionally, the rotating shaft housing may be coupled to the bearing(s).

A compressor housing 250 may at least partially enclose a compressor rotor assembly 252, allowing intake gas to be directed through the compressor. The compressor housing may have multiple layers for increasing the strength and insulating properties of the housing.

The compressor rotor assembly 252 includes a central compressor shaft 254 to which a plurality of compressor blades 256 is attached. The central compressor shaft may be coupled to the rotating shaft 218. Intake gas may be directed through the compressor, allowing the intake gas to be compressed. Specifically, intake gas may be directed longitudinally into the compressor rotor assembly and then may be directed away from the compressor rotor assembly in a direction having radial components (e.g., into and out of the page from the central axis of rotation).

The aforementioned shaft and coupling components (rotating shaft 218, compressor shaft 254, turbine shaft 234, extension coupling 232, shaft extension 220, etc.) may comprise a single integrated shaft unit (e.g., the compressor blades, turbine blades, and rotor are all attached to or otherwise integrated with a central shaft unit), or the shaft and coupling components may comprise separate elements that are securely axially attached to one another.

FIG. 3 shows a second embodiment of an example configuration of an integrated turbo-boosting system 300. Similar components are labeled accordingly. As shown, an electric generation system 312 is integrated into a compressor 316 included in turbo-boosting device 310. In particular, a compressor rotor assembly 320 includes a central rotating shaft 322 to which a plurality of compressor blades 324 is attached. Intake gas may be flowed or directed around the compressor rotor assembly 320, facilitating heat transfer from the compressor rotor assembly to the lower temperature intake gas. In this example, the compressor rotor assembly may be at least partially formed out of permanent magnetic material. Therefore, the rotor of the electric generation system may be included in the compressor rotor assembly. In particular, the blades 324 may be a least partially formed out of permanent magnetic material configured to withstand temperatures approaching approximately 550° F. (287.8° C.). In other examples, the compressor rotor assembly may be electrically magnetized. In some examples, during operating of an integrated turbo-boosting system, the compressor may reach temperatures between 200° F. and 400° F. (93.3° C. and 204° C.), well below the maximum temperature the magnetic material is designed to withstand, allowing for the electric generation system to properly and efficiently operate. Some examples of suitable permanent magnetic material include NdFeB and SmCo₅.

Furthermore, the compressor housing 326 may be the stator of the electric generation system. The compressor housing may be at least partially formed or constructed out of a conductive material 330 surrounded by a non-conductive material 332. In this example, the housing includes copper wire or copper wire mesh 330 woven into a housing, which may be at least partially formed out of a non-conductive ceramic material 332; thus the copper wire or wire mesh may be embedded in the ceramic material. Additionally in this example, the conductive material may be in a winding configuration. In other examples, alternate suitable conductive as well as non-conductive material may be utilized. Further, in other examples, alternate configurations of the conductive material may be utilized.

Rotation of the compressor rotor assembly 320 may generate an electro-magnetic field, inducing current in the conductive material (e.g. copper wire winding) included in the compressor housing. Electrical leads 328 may be coupled to the conductive material and an electrical system included in the engine system, thereby allowing electrical power to be extracted from the electric generation system.

The integrated turbo-boosting system may be operated in a first and/or a second mode, as discussed above. In the first mode the compressor may be driven by the turbine to compress intake gas. In the second mode the compressor, including the rotor, may be driven by the turbine, thereby electromagnetically interacting with the stator for producing electricity. As discussed above, operation in the second mode only is accomplished by bypassing intake air around the compressor. Operation in the first mode only may be accomplished by creating an open circuit condition between the stator and electrical system, e.g., by opening a switch to temporarily disconnect the stator from the electrical system.

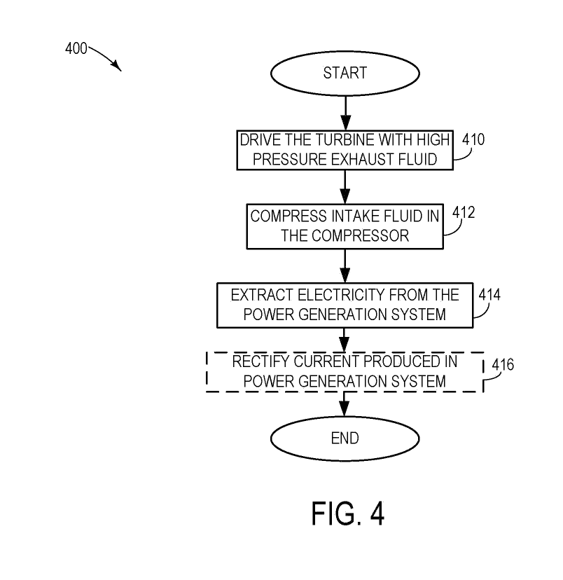

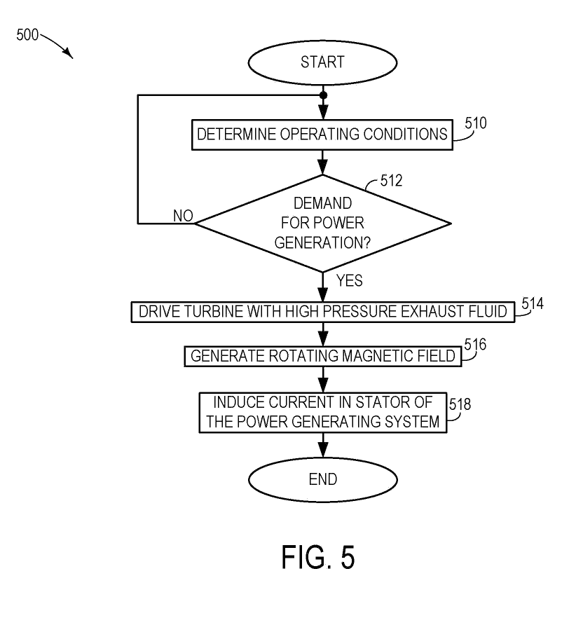

Various methods are described in FIGS. 4-5 to illustrate exemplary operation of an integrated turbo-boosting system. Specifically, FIG. 4 shows a flow chart illustrating a method 400 of generating electrical power from an integrated turbo-boosting system during normal operation of the engine. Normal operation of the engine includes operation of the engine to perform combustion in the combustion chamber(s). FIG. 5 illustrates a method 500 which may be used to determine the amount of electrical power generation needed in the engine system, such as in a vehicle, and subsequently the method to extract the electrical power from an integrated turbo-boosting system. Methods 400 and 500 may be implemented utilizing the system and components discussed above. Alternatively, method 400 and 500 may be implemented utilizing other suitable systems and components.

First, at 410 in FIG. 4, a turbine is driven with high pressure gas/fluid from an exhaust. Next, at 412 an intake gas/fluid is compressed in a compressor (e.g., the turbine rotatably drives the compressor, with the rotation of the compressor compressing the intake gas). The compression of the intake gas generates mechanical power such that the integrated turbo-boosting system is operating in a first mode, namely, a mechanical power generating mode.

At 414, electricity is extracted from an electric power generation system integrated into a turbo-boosting device (e.g., the turbo-boosting device includes the turbine and compressor). When the integrated turbo-boosting system is extracting or generating electricity, the integrated turbo-boosting system is operating in a second mode, namely, an electric power generating mode.

At 416, the current produced by the electric power generation system may be rectified. In another additional step, between 412 and 414, intake gas may be flowed around the electric power generation system. In particular, intake gas may be flowed around a rotor portion of the power generation system to facilitate heat transfer from the rotor to the lower temperature intake gas.

Referring now to FIG. 5, a flow chart illustrates a second example method 500, where boosting is provided to the engine and electrical energy is extracted from an integrated turbo-boosting system.

At 510, the operating conditions of the engine system are determined. The operating conditions may include: electrical power consumption, requested electrical power generation, ambient temperature, EGR temperature, throttle position, engine temperature, emission control device temperature, exhaust gas composition, intake air pressure, exhaust gas flowrate, etc.

Next, at 512, it is determined if there is a demand for electrical generation in the engine system or elsewhere, such as in the vehicle. A demand for electrical power generation may include a request from various systems including an audio and/or visual system, such as a stereo or display device, a cabin heating system, battery charger, etc. If it is determined that there is not a demand for electrical generation the method returns to the start. However, if it is determined that there is a demand for electrical generation, the method advances to 514, where a turbine included in a turbo-boosting system is driven by high pressure exhaust gas/fluid.

Next the method advances to 516, where a rotating magnetic field is generated by the rotation of a rotor included in the turbo-boosting device, such as in the compressor, at least partially composed out of a magnetic material. Next the method proceeds to 518, where current is induced in a stator integrated into the turbo-boosting device. In this way electrical energy may be extracted from the turbo-boosting system while operation of the turbo-boosting device to compress intake gas is not needed.

Although the integrated turbo-boosting system is described in regard to an engine system, such as an engine system for a vehicle, it should be appreciated that the integrated turbo-boosting system may be adapted for use in other engine systems. For example, the integrated turbo-boosting system may be adapted for use in facility engine systems, such as engine systems used in large buildings.

As should be appreciated, in another embodiment (not separately illustrated), the features and components shown in FIGS. 2 and 3 could be combined. For example, it could be possible to replace the rotor 224 in FIG. 2 with the compressor rotor assembly 320, having magnetic blades 324, shown in FIG. 3, whereby if it was desired to compress intake air both the non-magnetic compressor 216 and magnetic rotor assembly 320 would work in concert for doing so. Another option would be to replace the compressor blades 256 in FIG. 2 with magnetic compressor blades 324 from FIG. 3, along with modifying the compressor housing 250 to include a suitably arranged conductor(s) 330 embedded in a non-conductive housing material 332. In such an embodiment, the electrical generating characteristics of the rotor-based electric generation system 212 could be made different from the electrical generating characteristics of the magnetic compressor blade-based electric generation system 312, for selectively/controllably providing different electrical power output waveforms.

In another embodiment (not separately illustrated), although the rotor 224 and compressor 216 of FIG. 2 are shown as being disposed in a common air intake passage 222, the rotor 224 could instead be fluidly separated or isolated from the compressor (e.g., by using a housing/bearing arranged such as the one operably connecting the turbine and compressor in FIG. 2). For example, intake air could be drawn into the compressor, routed to an intercooler or other intermediate component, and then directed to and around the rotor and subsequently to the engine intake. Thus, unless otherwise specified herein, characterizations of intake air or other gas/fluid being directed around the electric generation system (e.g., rotor) includes gas/fluid upstream or downstream of the compressor.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

1. An integrated turbo-boosting system for an engine system including an internal combustion engine, the integrated turbo-boosting system comprising:
a turbo-boosting device including a compressor coupled to a turbine by a rotating shaft, the turbine driven by an exhaust gas; and
an electric generation system integrated into a portion of the turbo-boosting device, the electric generation system configured to generate electricity for an electrical system, and where the electric generation system is at an operation temperature through direction of an intake gas around at least a portion of the electric generation system;
wherein the integrated turbo-boosting system is operated in a first mode to compress the intake gas for supply to the engine and a second mode to generate electrical power.

2. The integrated turbo-boosting system of claim 1, wherein the electric generation system includes a rotor configured to electro-magnetically interact with a stator.

3. The integrated turbo-boosting system of claim 2, wherein the turbo-boosting device includes a shaft extension attached to the shaft and extending in an axial direction away from the compressor and the shaft, the rotor of the electric generation system integrated into the shaft extension.

4. The integrated turbo-boosting system of claim 3, wherein the shaft extension is at least partially positioned within an intake passage fluidly communicating with the compressor and ambient or intake air upstream of the compressor, the intake passage being defined by a housing including the stator, the housing enclosing at least a portion of the rotor.

5. The integrated turbo-boosting system of claim 4, further comprising a coupling positioned between the electric generation system and the compressor, sharing a rotating axis with the compressor and the rotating shaft, the coupling having non-heat transferring properties.

6. The integrated turbo-boosting system of claim 2, wherein the compressor includes a compressor housing and a compressor rotor assembly having a plurality of blades, the compressor housing forming at least a portion of the stator, and the compressor rotor assembly forming at least a portion of the rotor.

7. The integrated turbo-boosting system of claim 2, wherein the rotor is at least partially formed out of a permanent magnetic material.

8. The integrated turbo-boosting system of claim 2, wherein the rotor is an electro-magnet.

9. The integrated turbo-boosting system of claim 1, wherein the engine system is included in a vehicle.

10. The integrated turbo-boosting system of claim 1, wherein the turbo-boosting device is a variable geometry turbocharger configured to adjust a compression ratio, of the turbo-boosting device, in response to a number of operating conditions including one of requested torque and electrical power demand.

11. The integrated turbo-boosting system of claim 1, wherein the first mode and the second mode are implemented substantially concurrently.

12. The integrated turbo-boosting system of claim 1, wherein the second mode is implemented in response to a request for electrical power.

13. The integrated turbo-boosting system of claim 1, wherein the second mode is implemented and the first mode is discontinued in response to an increase in electrical power consumption and a decrease in requested torque.

14. An integrated turbo-boosting system for an engine system including an internal combustion engine, the integrated turbo-boosting system comprising:
a turbo-boosting device including a turbine coupled to a compressor by a rotating shaft, the compressor including a compressor rotor assembly having a plurality of blades, the compressor rotor assembly at least partially surrounded by a first housing, the first housing at least partially constructed out of a non-conductive material and a conductive material; and
an electrical system coupled to the conductive material;
wherein the compressor rotor assembly is at least partially composed out of a permanent magnetic material electromagnetically interacting with the conductive material.

15. The integrated turbo-boosting system of claim 14, wherein the first housing is coupled to a second housing at least partially enclosing the rotating shaft.

16. The integrated turbo-boosting system of claim 14, wherein the conductive material is copper wire embedded in the non-conductive material.

17. The integrated turbo-boosting system of claim 14, wherein the electrical system includes a battery configured to store energy when a demand for electrical power is not present in the engine system.

18. A method for control of an integrated turbo-boosting system included in an internal combustion engine having a combustion chamber with an intake system and an exhaust system, the integrated turbo-boosting system having a turbo-boosting device with a turbine positioned downstream of the exhaust and a compressor, having a compressor rotor assembly, positioned upstream of the intake system, a rotating shaft coupling the turbine and the compressor, and an electric generation system integrated into the turbo-boosting device, the method comprising:
driving the turbine with exhaust gas;
compressing intake gas in the compressor to for supply to the engine in a first mode;
extracting electricity from the electric generation system to generate electrical power in a second mode; and
flowing intake air around at least a portion of the electric generation system.

19. The method according to claim 18, wherein the portion of the electric generation system is a rotor included in the electric generation system.

20. The method according to claim 18, wherein electrical energy is extracted from the electric generation system in response to a demand for electrical power in the engine system.
